(19) United States
(12) Patent Application Publication
(10) Pub. No.: US 2021/0205852 A1
(43) Pub. Date: Jul. 8, 2021

(54) A METHOD OF RECYCLING MIXED MAIL INTO A SORTING MACHINE BY USING LETTER TRAYS

(71) Applicant: SOLYSTIC, Bagneux (FR)

(72) Inventors: Cedric Milord, Marches (FR); Bruno Cartal, Montelier (FR); Frederic Mestrallet, Etoile sur Rhone (FR); Karine Crest, Etoile sur Rhone (FR)

(21) Appl. No.: 16/070,827

(22) PCT Filed: Jun. 15, 2018
(86) PCT No.: PCT/FR2018/051432

§ 371 Date: Jul. 18, 2018

(30) Foreign Application Priority Data
Aug. 3, 2017 (FR) 1757470

(51) Int. Cl. B07C 3/00; B07C 3/08; B65H 1/02

(52) U.S. Cl. CPC B07C 3/008; B07C 3/08; B65H 2701/1916; B65H 2405/20; B65H 1/02

(57) ABSTRACT

A method of processing mailpieces in a sorting installation including a feed inlet magazine (4) in which the mailpieces (1) for sorting are placed in a stack and on edge so as to be put in series in a sorting conveyor (5), the mailpieces (1) in series and on edge in the sorting conveyor being directed towards sorting outlets having respective stackers (6). The mailpieces (1) for sorting that arrive at the feed inlet magazine while stored in a tray (3) are taken in handfuls from the storage tray to be positioned in a stack and on edge in order to be put into series. The mailpieces (1) sorted into a stacker of a sorting outlet (6) are also transferred in handfuls from the stacker towards a storage tray (3) for the purpose of being recycled to the feed inlet magazine (4) from the sorting outlet (6) having a stacker.

### TECHNICAL FIELD

The present invention relates to a method of processing mailpieces in a sorting installation including a feed inlet magazine in which the mailpieces for sorting are placed in a stack and on edge so as to be put in series in a sorting conveyor, the mailpieces in series and on edge in the sorting conveyor being directed towards sorting outlets having respective stackers, the mailpieces for sorting that arrive at the magazine while stored in a tray being taken in handfuls from the storage tray to be positioned in a stack and on edge in order to be put into series, and the mailpieces sorted into a stacker of a sorting outlet being transferred in handfuls from the stacker towards a storage tray for the purpose of being recycled to the inlet magazine from said sorting outlet.

### PRIOR ART

Nowadays, mailpiece sorting installations for sorting non-mixed mailpieces, such as the installation described in Document WO-A-2016/054103, are widely known. Mailpiece sorting installations are also known that are designed to machine-sort mixed mail, i.e. mail including C5-format letters and large-format mail or “flats”, e.g. C4-format envelopes.

Since the sizes of such mailpieces vary over a broad spectrum, those sorting machines use storage trays that are of sufficient size to enable both letters and large-format mail to be stored on edge.

Unfortunately, such specific trays increase the operating costs of the machines.

An object of the invention is to remedy those drawbacks.

To this end, the invention provides a method of processing mailpieces in a sorting installation including a feed inlet magazine in which the mailpieces for sorting are placed in a stack and on edge so as to be put in series in a sorting conveyor, the mailpieces in series and on edge in said sorting conveyor being directed towards sorting outlets having respective stackers, the mailpieces for sorting that arrive at said feed inlet magazine while stored in a tray being taken in handfuls from the storage tray to be positioned in a stack and on edge in order to be put into series, and the mailpieces sorted into a stacker of a sorting outlet being transferred in handfuls from the stacker towards a storage tray for the purpose of being recycled to said feed inlet magazine from said sorting outlet having a stacker, said method being characterized in that the mailpieces are mixed mailpieces including letters and large-format postal articles, in that, in a sorting outlet, the mailpieces that are stored in a stacker in landscape mode are taken in handfuls and are pivoted so as to be stored on edge in portrait mode in the storage tray, and in that, in the feed inlet magazine, a storage tray with mailpieces stored on edge in portrait mode is pivoted onto one side so as to present said mailpieces on edge in landscape mode before they are extracted in handfuls.

These characteristics contribute to making it possible, in particular in an existing sorting installation, to use existing trays, in particular letter trays, for processing mixed mail, without losing the sorting sequence while the trays are being recycled from the sorting outlets to the inlet magazine of the machine.

The mixed mail can also be transferred using letter trays from the sorting outlets of the machine towards a feed inlet magazine of another machine, or indeed towards a storage zone or a bundling zone or the like in an inward sorting center.

### BRIEF DESCRIPTION OF THE DRAWING

In the drawing:

FIG. 1 is a very diagrammatic view of a mailpiece sorting installation adapted to implement the mailpiece processing method of the invention;

FIG. 2 is a diagrammatic view of a storage tray loaded with mixed mailpieces in portrait mode at a stacker of a sorting outlet, which stacker is shown in fragmentary manner; and

FIG. 3 is a diagrammatic view of a storage tray loaded with mixed mailpieces that is tipped onto a feed inlet magazine so as to present the mailpieces in landscape mode, the magazine being shown in fragmentary manner.

The invention is described in more detail below with reference to the accompanying drawing that shows an example of a sorting installation and of a tray that are used for processing mailpieces using the method of the invention.

### DESCRIPTION OF IMPLEMENTATIONS

The method of the invention makes it possible to sort mixed mail 1 in a sorting installation 2 by using standard storage trays 3, in particular trays designed to store envelopes of up to a maximum format corresponding to C5.

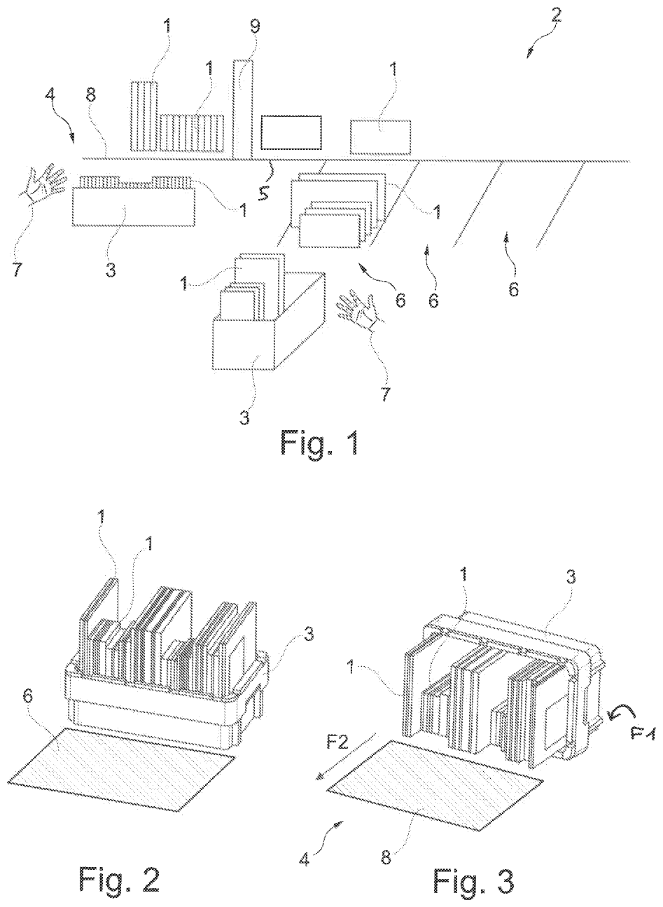

As shown in FIG. 1, the sorting installation 2 in this example includes an unstacker with a feed inlet magazine 4 in which a machine operative places the mailpieces 1 for sorting in a stack and on edge (the mailpieces, which thus form mixed mail in this example, are shown edge-on in the magazine).

In this example, downstream from the unstacker, the installation includes a sorting conveyor 5 suitable for transporting the mailpieces 1 in series and on edge (in the unstacker, the mailpieces are shown face-on), after the mailpieces have been put in series by the unstacker, and said mailpieces are sorted into sorting outlets 6, which, in this example, have respective stackers.

Said sorting outlets 6 having stackers are designed to accumulate a certain number (several tens) of sorted mailpieces 1 and to store them in a stack and on edge.

In this example, the trays 3 are used to take the mailpieces 1 that are stored in the sorting outlets 6 and to recycle them to the feed inlet magazine 4.

As shown in FIG. 1, a machine operative 7 has placed a tray 3 at the stacker of a sorting outlet so as to take handfuls of the mailpieces stored on edge in landscape mode in the stacker of the sorting outlet 6 and so as to transfer them to the tray 3 while placing them on edge in portrait mode, while also preserving the order of the sequence of the mailpieces 1.

In this example, the trays are letter trays that are quite small in size.

Said letter trays 3 have a tray width of about 22 centimeters (cm), which is sufficient to store mailpieces 1 of large format (A3 format) on edge in portrait mode, as shown in FIG. 2.

The tray 3 loaded with mailpieces 1 placed on edge in portrait mode is then transported automatically to the feed inlet magazine 4.

In FIG. 1, the inlet magazine 4 is shown with a moving floor 8 that is mounted to move towards an unstacker head 9 that puts the mailpieces in series at the inlet of the sorting conveyor 2.

In the inlet magazine 4, the machine operative 7 takes hold of the tray 3 and tips it over onto one of its long sides, as indicated by the curved arrow F1.

The tray 3 as tipped over onto its side is situated along the floor 8 of the inlet magazine, as shown in FIG. 3.

The mailpieces 1 stored in the tray 3 are then in landscape mode.

The machine operative 7 transfers the mailpieces 1 in handfuls from the tray 3 towards the floor 8 by causing them to slide on their long edges as indicated by arrow F2 in FIG. 3.

The mailpieces taken from the tray 3 are then put in a stack and on edge in landscape mode on the floor 8 of the inlet magazine 4, which causes the stack to move towards the unstacker 9.

In the unstacker 9, the mailpieces 1 are put in series and on edge in landscape mode, as shown in FIG. 1.

It can be understood that changing position from landscape mode to portrait mode and vice versa makes it possible to use storage trays of small dimensions for handling mixed mail with letters and large-format mail, in particular storage trays initially designed to store letters in landscape mode only.

What is claimed is:

1. A method of processing mailpieces in a sorting installation comprising the steps of:
placing the mailpieces for sorting in a feed inlet magazine of the sorting installation so that the mailpieces are placed in a stack and on edge so as to be put in series in a sorting conveyor, of the sorting installation;
directing the mailpieces in series and on edge in said sorting conveyor towards sorting outlets having respective stackers;
the mailpieces for sorting that arrive at said feed inlet magazine while stored in a tray being taken in handfuls from said storage tray to be positioned in a stack and on edge in order to be put into series; and
the mailpieces sorted into a stacker of a sorting outlet being transferred in handfuls from the stacker towards a storage tray for the purpose of being recycled to said feed inlet magazine from said sorting outlet having a stacker;
wherein the mailpieces, are mixed mailpieces including letters and large-format postal articles;
wherein in a sorting outlet, the mailpieces that are stored in a stacker in landscape mode are taken in handfuls and are pivoted so as to be stored on edge in portrait mode in the storage tray; and
wherein in the feed inlet magazine, a storage tray with mailpieces stored on edge in portrait mode is pivoted onto one side so as to present said mailpieces on edge in landscape mode before they are extracted in handfuls.
